(19) United States
(12) Patent Application Publication
(10) Pub. No.: US 2002/0174337 A1
(43) Pub. Date: Nov. 21, 2002

(54) Memory card with wireless communication function and data communication method

(76) Inventor: Tadahiro Aihara, Hachioji-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/132,254

(22) Filed: Apr. 26, 2002

(30) Foreign Application Priority Data
Apr. 27, 2001 (JP) 2001-133294

(51) Int. Cl. H04L 9/00

(52) U.S. Cl. 713/172; 713/150

(57) ABSTRACT

A card includes a memory configured to rewritably store data, a communication unit configured to transmit/receive data via a wireless communication, an interface connectable to an external device, and a controller configured to execute direct access control to the memory via the communication unit. The controller is set in a direct access mode by a command supplied via the interface (or by an operation of a switch).

### CROSS-REFERENCE TO RELATED APPLICATIONS

This application is based upon and claims the benefit of priority from the prior Japanese Patent Application No. 2001-133294, filed Apr. 27, 2001, the entire contents of which are incorporated herein by reference.

### BACKGROUND OF THE INVENTION

1. Field of the Invention

The present invention relates to a memory card with a wireless communication function and, more particularly, to a memory card which also has a security function.

2. Description of the Related Art

In recent years, various digital devices (especially, portable digital devices) with wireless data communication functions have been developed. Such electronic devices include, for example, a portable information terminal called a PDA (Personal Digital Assistant), portable telephone, portable audio device, digital camera, and the like in addition to a personal computer.

If a wireless data communication can be made among such digital devices, the need for cable connection can be obviated, thus improving convenience. In order to implement such function, a wireless communication IC card having a wireless communication function capable of a near-distance wireless communication has been developed. This IC card is prepared by integrating building components such as an interface which is physically connected (via wire) to an electronic device, an antenna, an RF processor (radio signal transmission/reception processor), a baseband processor (baseband signal processor), and the like.

On the other hand, the data size to be handled by a digital device such as a PDA, digital camera, or the like is increasing, and a large-capacity memory is required. For this reason, it is effective to assure a memory capacity using a detachable memory card as well as an increase in memory capacity of a flash memory or the like built in the main body.

If a digital device such as a PDA or the like can make a wireless data communication with another electronic device such as a personal computer or the like, its convenience can be improved very much. Also, it is effective to use a detachable memory card in addition to an internal memory to increase the memory capacity. Under such circumstance, a hybrid memory card which combines the data communication function of a wireless communication IC card and the data saving function of a memory card has been proposed. This memory card implements a data communication between digital devices by the wireless communication function, and can save a given size of data in a flash memory in the card.

However, upon actually making a data communication between digital devices which mount the hybrid memory cards, the following problems are posed.

First, when a data communication is made between digital devices connected to the cards by the wireless communication function, data transfer with a memory in the card requires a long time. This is because, upon making a data communication, data obtained by the wireless communication function or data read out from the memory is temporarily stored in the internal memory of the digital device, and is then transferred to the memory in the card. In other words, the memory in the card cannot be directly accessed. Second, the security function of data which is input/output to/from the memory in the card is insufficient.

### BRIEF SUMMARY OF THE INVENTION

Accordingly, it is an object of the present invention to provide a memory card and data communication method capable of attaining high-speed data transfer to/from a memory in the card. It is another object of the present invention to provide a memory card and data communication method capable of securely protecting data input/output to/from the memory in the card by a security function.

According to one aspect of the present invention, there is provided a card, comprising: a memory configured to rewritably store data; a communication unit configured to transmit/receive data via a wireless communication; an interface connectable to an external device; and a controller configured to execute direct access control to the memory via the communication unit, the controller being set in a direct access mode by a command supplied via the interface.

According to another aspect of the present invention, there is provided a card, comprising: a memory configured to rewritably store data; an encryption processor configured to execute an encryption/decryption process of data to be written in the memory or data read out from the memory; a communication unit configured to transmit/receive data via a wireless communication; an interface connectable to an external device; and a controller configured to execute direct access control to the memory via the communication unit and ON/OFF control of the encryption processor, the controller being set in a direct access mode and a security mode by a command supplied via the interface.

According to still another aspect of the present invention, there is provided a card, comprising:

a memory configured to rewritably store data;

a communication unit configured to transmit/receive data via a wireless communication; an interface connectable to an external device; a switch configured to set a direct access function; and a controller configured to execute direct access control to the memory via the communication unit, the controller being set in a direct access mode by an operation of a switch.

According to still another aspect of the present invention, there is provided a wireless communication method applied to a system having a first electronic device using a first card and a second electronic device using a second card, the method comprising:

accessing from the first electronic device via the first card to the second card by wireless communication; and executing direct access control to a memory in the second card by the second card in response to the accessing from the first electronic device, the second card being set in a direct access mode by a command supplied from the second electronic device.

According to still another aspect of the present invention, there is provided a wireless communication method applied to a system having a first electronic device using a first card and a second electronic device using a second card, the method comprising:

accessing from the first electronic device via the first card to the second card by wireless communication; and executing direct access control to a memory in the second card by the second card in response to the accessing from the first electronic device, the second card being set in a direct access mode by an operation of a switch.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram for explaining the internal arrangement of a memory card according to an embodiment of the present invention;

FIG. 2 is a block diagram for explaining a data communication by the memory card according to the embodiment;

FIG. 3 is a block diagram showing an example of a digital device according to the embodiment;

FIG. 4 is a flow chart showing the data reception sequence by direct access according to the embodiment;

FIG. 5 is a flow chart showing the data transmission sequence by direct access according to the embodiment;

FIG. 6 is a flow chart showing the data reception sequence including a security process according to the embodiment;

FIG. 7 is a flow chart showing the data transmission sequence including a security process according to the embodiment;

FIG. 8 is a view for explaining an external switch circuit for direct access setup according to a modification of the embodiment; and

FIGS. 9A and 9B are views for explaining the detailed arrangement of the external switch circuit.

### DETAILED DESCRIPTION OF THE INVENTION

Embodiments of the present invention will be described hereinafter with reference to the accompanying drawings.

### Arrangement of Memory Card and System

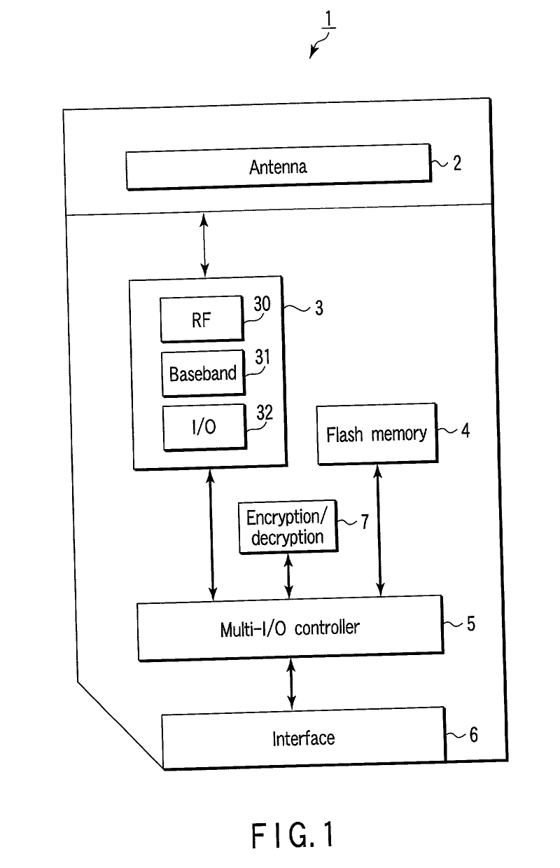

FIG. 1 is a block diagram showing the internal arrangement of a memory card 1 with a wireless communication function according to an embodiment of the present invention.

The card 1 includes an antenna 2, wireless communication controller 3, flash memory 4, multi-I/O controller 5, interface 6, and encryption processing IC (encryption processor) 7 for encrypting/decrypting data.

The antenna 2 and wireless communication controller 3 are building components required to implement a near-distance wireless communication function based on a predetermined communication protocol. More specifically, the wireless communication controller 3 includes an RF processor 30, baseband processor 31, and I/O processor 32. The RF processor 30 is a circuit for processing RF signals to be transmitted via the antenna 2. The baseband processor 31 executes a modulation/demodulation process of a baseband signal (data signal), and a security process such as an authentication process, encryption/decryption process, and the like.

The interface 6 is a bus interface complying with a predetermined memory card interface standard, and can be physically connected (via wire) to an interface connected to a digital device (host device) such as a PDA, personal computer, or the like. The interface 6 also serves as a component for receiving power supply for the card, which is supplied from the host device.

The encryption processing IC 7 implements a data security function by decrypting encrypted data or encrypting data. The multi-I/O controller 5 executes switching control of access between the interface 6 and flash memory 4, and access between the interface 6 and wireless communication controller 3. Furthermore, the multi-I/O controller 5 executes direct access control (setup control of a direct access mode) between the wireless communication controller 3 and flash memory 4 in accordance with a command supplied from the host device via the interface 6. This corresponds to control of a file transfer protocol as a generic concept of baseband. The multi-I/O controller 5 controls the operation of the encryption processing IC 7 in accordance with a command supplied from the host device via the interface 6 to ON/OFF-control the encryption/decryption function. That is, the multi-I/O controller 5 controls to set a security or non-security mode of data that the flash memory 4 inputs/outputs.

FIG. 3 is a block diagram showing the arrangement of a PDA 10 as an example of the digital device. This embodiment assumes a system in which the PDA 10 as a host device and a personal computer (PC) 20 make wireless data communications using the cards 1.

The PDA 10 includes a microprocessor (CPU) 100, external interface 101, liquid crystal display (LCD) 102, EEPROM 103 as an internal memory, key input interface 104, and RAM 105.

The external interface 101 physically connects the memory card 1 of this embodiment via the interface 6. The LCD 102 displays data processed by the CPU 100. The EEPROM 103 is an electrically erasable IC memory, and stores programs for controlling the memory card 1 of this embodiment. The key input interface 12 executes a key input process from a keyboard. The RAM 105 is used as a work area required when the CPU 100 processes the programs.

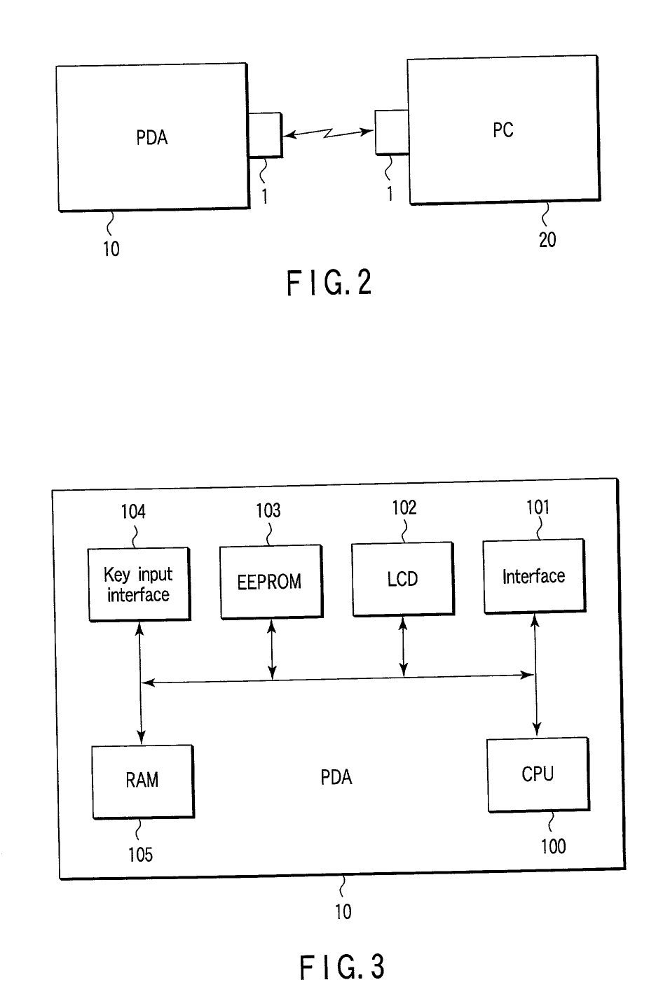

The PDA 10 downloads a required program and data from the flash memory 4 in the card 1 or uploads them using the memory card 1 of this embodiment. The PDA 10 can execute a wireless data communication with the PC 20 as another digital device using the memory cards 1 (see FIG. 2).

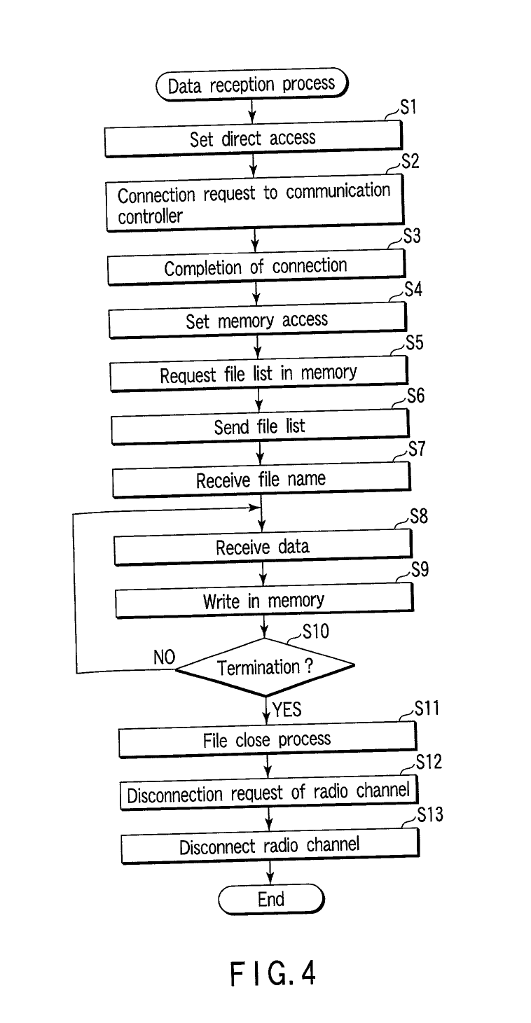

The data communication sequence using the memory card 1 of this embodiment will be explained below with reference to the flow charts in FIGS. 4 to 7.

### Data Reception by Direct Access

The data reception sequence by direct access according to this embodiment will be described first with reference to the flow chart in FIG. 4.

In the following description, a data transfer operation executed when the PDA 10 receives data sent from the personal computer (PC) 20 and stores it in the flash memory 4 of the memory card 1 will be explained. In this case, data sent from the personal computer 20 is directly transferred to the memory card 1 by direct access control.

The PDA 10 sets a direct access command in the multi-I/O controller 5 via the interface 6 of the card 1 (step S1). The PC 20 then executes a connection request to the wireless communication controller 3 of the memory card 1 (step S2). The wireless communication controller 3 executes a predetermined connection process to establish connection of a radio channel to the PC 20 (step S3).

Upon completion of the connection process, the PC 20 executes a memory access setup process to the multi-I/O controller 5 of the card 1 using the radio channel (step S4). Upon completion of the memory access setup process, the PC 20 requests a list of files stored in the flash memory 4 (step S5). The memory card 1 sends the requested file list to the PC 20 via the radio channel (step S6).

Upon receiving a file name of data to be received from the PC 20, the memory card 1 waits for corresponding data sent from the PC 20 (step S7). Upon receiving data sent from the PC 20 via the radio channel, the memory card 1 writes the received data in the flash memory 4 (steps S8 and S9). After this process is repeated until it is ended, the memory card 1 closes a file (steps S10 and S11). After that, if the memory card 1 receives a disconnection request of the radio channel from the PC 20, the wireless communication controller 3 executes a disconnection process (steps S12 and S13).

With the aforementioned data communication sequence, the PDA 10 can directly transfer data sent from the PC 20 via the radio channel to the memory card 1. That is, the PDA 10 can directly store data sent from the PC 20 in the flash memory 4 of the memory card 1 using the wireless communication function of the memory card 1 without the intervention of its internal memory (RAM 105).

### Data Transmission by Direct Access

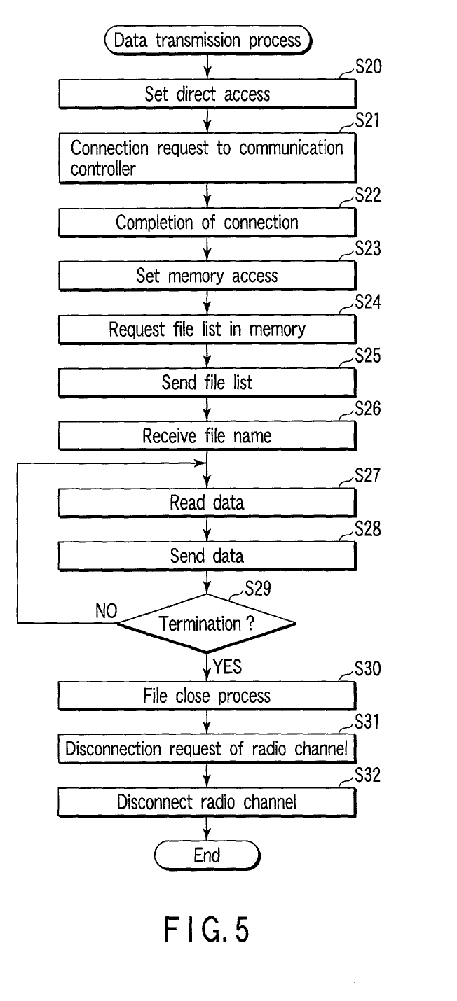

The data transmission sequence by direct access according to this embodiment will be described first with reference to the flow chart in FIG. 5.

A case will be exemplified below wherein the PDA 10 directly transfers data stored in the flash memory 4 of the memory card 1 to the PC 20.

As in the above sequence, the PDA 10 sets a direct access command in the multi-I/O controller 5 via the interface 6 of the card 1 (step S20). The PC 20 executes a connection request to the wireless communication controller 3 of the memory card 1 (step S21). The wireless communication controller 3 executes a predetermined connection process to establish connection of a radio channel to the PC 20 (step S22). Upon completion of the connection process, the PC 20 executes a memory access setup process to the multi-I/O controller 5 of the card 1 using the radio channel (step S23). Upon completion of the memory access setup process, the PC 20 requests a list of files stored in the flash memory 4 (step S24). The memory card 1 sends the requested file list to the PC 20 via the radio channel (step S25).

Upon receiving from the PC 20 a file name of data to be sent, the memory card 1 reads corresponding data from the flash memory 4 (steps S26 and S27).

The wireless communication controller 3 sends that data to the PC 20 via the radio channel (step S28). The memory card 1 repeats the sending process until the file of the data to be sent is ended, and closes that file completion of the process (steps S29 and S30). After that, if the memory card 1 receives a disconnection request of the radio channel from the PC 20, the wireless communication controller 3 executes a disconnection process (steps S31 and S32).

With the aforementioned data communication sequence, the PDA 10 can directly transfer data read out from the flash memory 4 of the memory card 1 to the PC 20 via the radio channel. That is, the PDA 10 can directly transfer data from the flash memory 4 of the memory card 1 to the PC 20 without the intervention of its internal memory (RAM 105).

Note that the PDA 10 can access the wireless communication controller 3 in place of the flash memory 4 by setting a predetermined command in the multi-I/O controller 5 via the interface 6, as a matter of course.

### Data Transmission/Reception Sequence Including Security Process

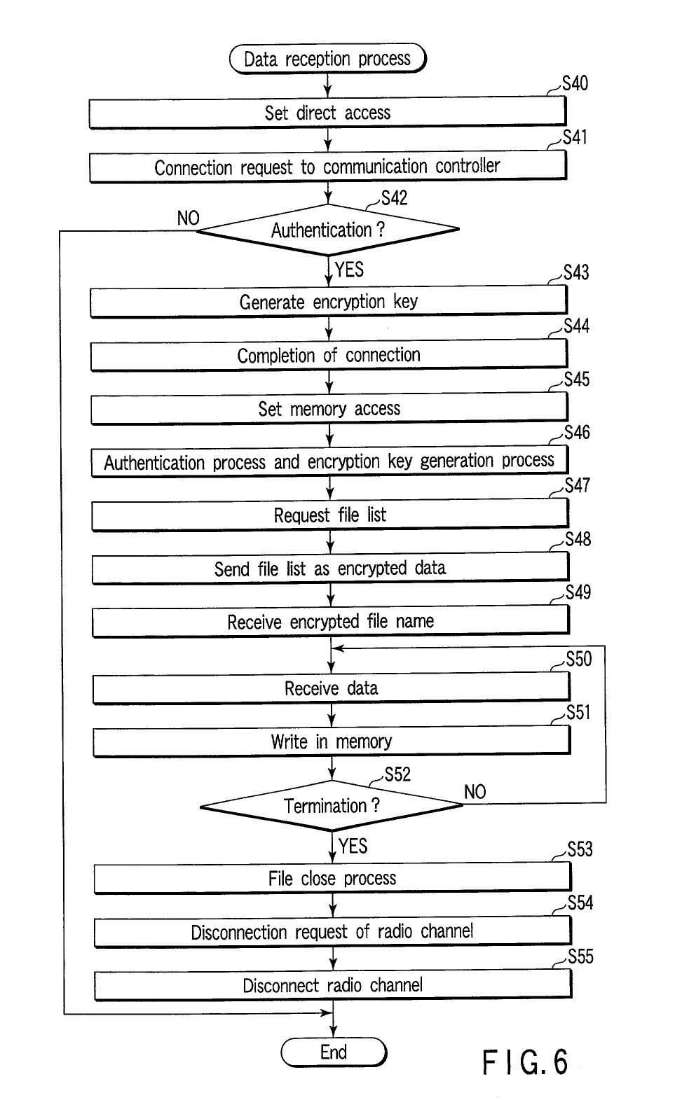

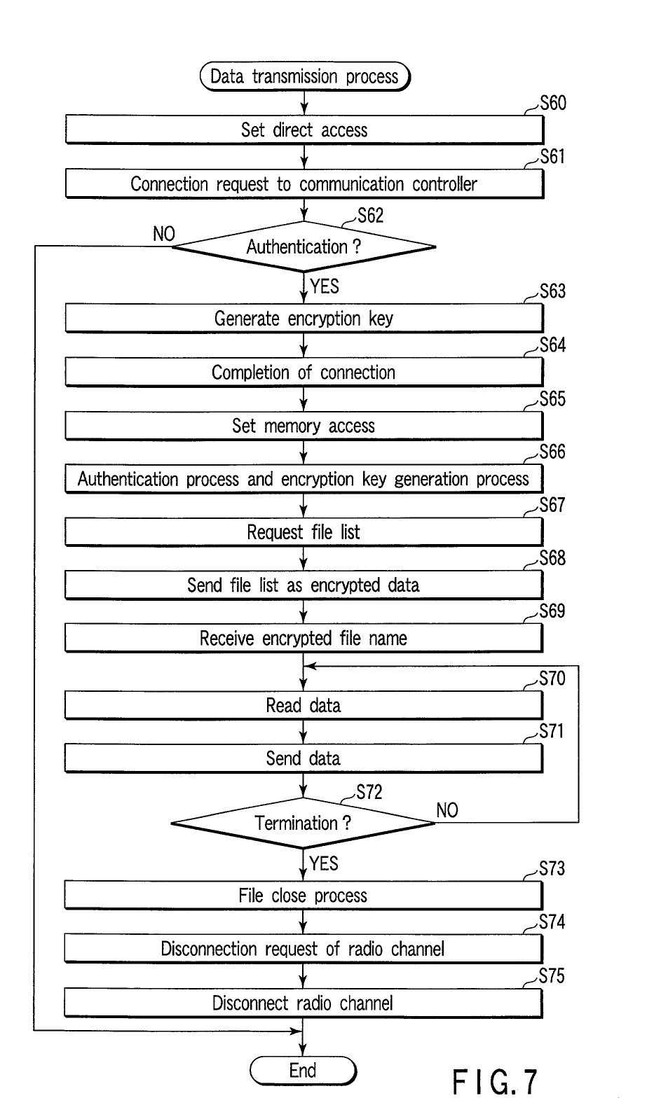

The data transmission/reception sequence including a security process of this embodiment will be explained below with reference to the flow charts in FIGS. 6 and 7.

In the data reception operation, as shown in FIG. 6, the PDA 10 sets direct access and security commands in the multi-I/O controller 5 via the interface 6 of the card 1 (step S40). The PC 20 executes a connection request to the wireless communication controller 3 of the memory card 1 (step S41).

Upon receiving this connection request, the wireless communication controller 3 executes an authentication process of the PC 20. If it is confirmed that the PC 20 as a connection destination is an authentic device, the wireless communication controller 3 executes a generation process of an encryption key used to encrypt (decrypt) data on a wireless communication (steps S42 and S43). If it is not confirmed that the PC 20 is an authentic device, the wireless communication controller 3 ends the process without establishing connection of a radio channel (NO in step S42).

Upon completion of the connection process, the PC 20 executes a memory access setup process to the multi-I/O controller 5 of the card 1 using the radio channel (steps S44 and S45). In this case, the encryption processing IC 7 executes an authentication process for the PC 20 and a generation process of an encryption key associated with input/output of the flash memory 4 (step S46). The encryption processing IC 7 encrypts/decrypts data to be written in/read out from the flash memory 4 using the generated encryption key 4.

Upon completion of the memory access setup process, the PC 20 requests a list of files stored in the flash memory 4 (step S47). The memory card 1 encrypts the requested file list using the encryption processing IC 7, and sends it to the PC 20 via the radio channel (step S48). In this case, the wireless communication controller 3 further encrypts that file list using the baseband processor 31 and sends it to the PC 20. The PC 20 can obtain the file list by decrypting it using the encryption key generated by the baseband processor 31 and also decrypting it using the encryption key generated by the encryption processing IC 7.

Upon receiving the file name of data to be received from the PC 20 as encrypted data, the memory card 1 waits for corresponding data to be received (step S49). At this time, the memory card 1 decrypts the file name using the encryption key generated by the baseband processor 31, and also decrypts it using the encryption key generated by the encryption processing IC 7 via the multi-I/O controller 5. Upon receiving data sent from the PC 20 via the radio channel, the memory card 1 writes that data in the flash memory 4 (steps S50 and S51). After this process is repeated until it is ended, the memory card 1 closes a file (steps S52 and S53). After that, if the memory card 1 receives a disconnection request of the radio channel from the PC 20, the wireless communication controller 3 executes a disconnection process (steps S54 and S55).

In the data transmission operation, as shown in FIG. 7, the PDA 10 sets direct access and security commands in the multi-I/O controller 5 via the interface 6 of the card 1 (step S60). The PC 20 executes a connection request to the wireless communication controller 3 of the memory card 1 (step S61).

Upon receiving this connection request, the wireless communication controller 3 executes an authentication process of the PC 20. If it is confirmed that the PC 20 as a connection destination is an authentic device, the wireless communication controller 3 executes a generation process of an encryption key used to encrypt (decrypt) data on a wireless communication (steps S62 and S63). If it is not confirmed that the PC 20 is an authentic device, the wireless communication controller 3 ends the process without establishing connection of a radio channel (NO in step S62).

Upon completion of the connection process, the PC 20 executes a memory access setup process to the multi-I/O controller 5 of the card 1 using the radio channel (steps S64 and S65). In this case, the encryption processing IC 7 executes an authentication process for the PC 20 and a generation process of an encryption key associated with input/output of the flash memory 4 (step S66).

Upon completion of the memory access setup process, the PC 20 requests a list of files stored in the flash memory 4 (step S67). The memory card 1 encrypts the requested file list using the encryption processing IC 7, and sends it to the PC 20 via the radio channel (step S68). In this case, the wireless communication controller 3 further encrypts that file list using the baseband processor 31 and sends it to the PC 20. The PC 20 can obtain the file list by decrypting it using the encryption key generated by the baseband processor 31 and also decrypting it using the encryption key generated by the encryption processing IC 7.

Upon receiving from the PC 20, the file name of data to be sent as encrypted data, the memory card 1 decrypts the file name using the encryption key generated by the baseband processor 31, and also decrypts it using the encryption key generated by the encryption processing IC 7 via the multi-I/O controller 5 (step 569). The memory card 1 reads data corresponding to the received file name from the flash memory 4 (step S70). The wireless communication controller 3 sends that data to the PC 20 via the radio channel (step S71). The memory card 1 repeats the sending process until the file of the data to be sent is ended, and closes that file completion of the process (steps S72 and S73). After that, if the memory card 1 receives a disconnection request of the radio channel from the PC 20, the wireless communication controller 3 executes a disconnection process (steps S74 and S75).

With the aforementioned data communication sequence, data can be directly transferred between the flash memory 4 of the memory card 1 and the PC 20 via a radio channel. Furthermore, since transfer data is encrypted (decrypted) by the encryption processing IC 7, a security function of data input/output to/from the flash memory 4 can be implemented. In this embodiment, the encryption processing IC 7 executes an encryption (decryption) process of the file list and file name. Of course, other data exchanged with the PC 20 can also be encrypted (decrypted).

### Modification

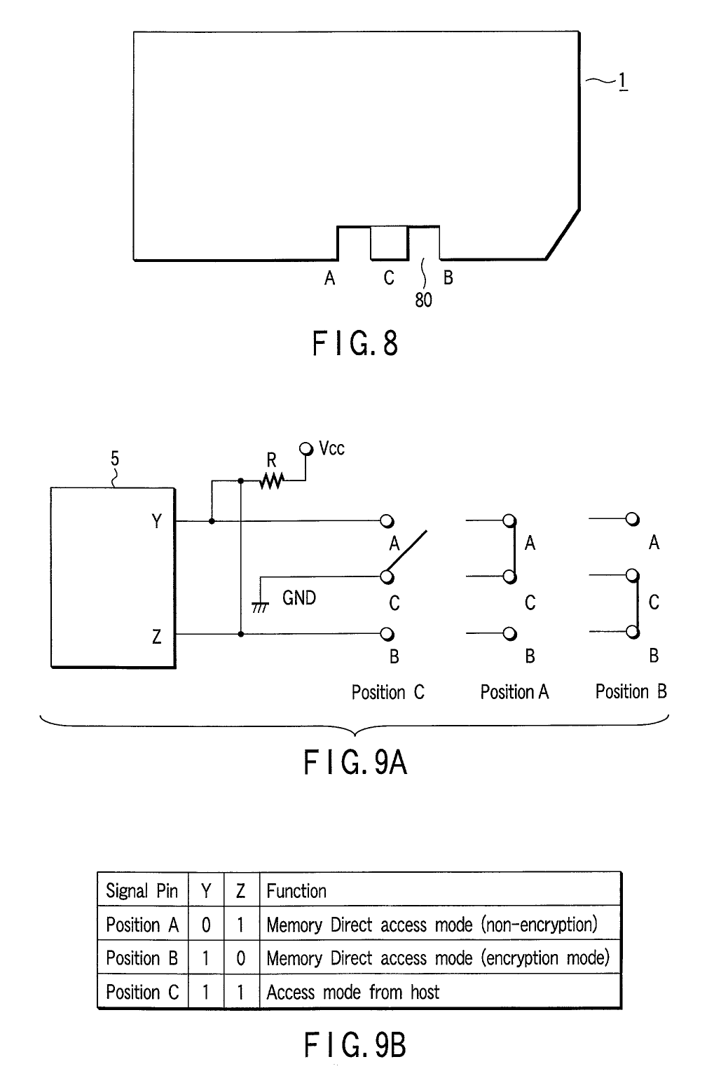

FIG. 8 and FIGS. 9A and 9B are views showing a modification of this embodiment.

This modification relates to an external switch circuit 80 which allows the user to manually set the ON/OFF state of the direct access setup in place of a command from the interface 6. The external switch circuit 80 is configured to set a direct access setup function by positions (contacts) A, B, and C of a switch, as shown in FIG. 8.

More specifically, the external switch circuit 80 has an arrangement shown in FIG. 9A, and is connected to the multi-I/O controller 5. FIG. 9B shows the contents of functions set in correspondence with switch positions A to C.

That is, when the switch is set at position C, since contact C contacts neither contact A nor contact B, input signals of logic “1” are input to input terminals Y and Z of the multi-I/O controller 5. In this case, an access mode from the PDA 10 as the host device is set, as shown in FIG. 9B, and a direct access mode with respect to the flash memory 4 of the card 1 does not function. When the switch is switched to position A, contacts A and C are connected, and contact A is connected to GND. In this case, input signals of logic “0” and logic “1” are respectively input to input terminals Y and Z of the multi-I/O controller 5, thus setting a non-security mode and direct access mode. That is, data input/output to/from the flash memory 4 is not encrypted. Furthermore, when the switch is switched to position B, contacts B and C are connected, and contact B is connected to GND. In this case, input signals of logic “1” and logic “0” are respectively input to input terminals Y and Z of the multi-I/O controller 5, thus setting a security mode and direct access mode. That is, data input/output to/from the flash memory 4 is encrypted.

Note that the data transmission/reception sequence of this modification is the same as that shown in the flow charts in FIGS. 4 to 7 in the above embodiment.

In the above embodiment and modification, the PDA 10 and PC 20 are assumed as digital devices which serve as host devices of the memory cards 1. However, the present invention is not limited to such specific devices, and can be applied to a digital camera, portable telephone, PHS, and the like. In the above embodiment, a data communication as a combination of the wireless communication interface and wired interface has been exemplified. However, the present invention is not limited to such specific communication, and can be implemented by a combination of, e.g., a card interface and wireless LAN.

As described above, according to the present invention, in a hybrid memory card which has both a wireless communication function and memory function, 1) when a data communication is made between digital devices which mount the memory cards, the memory of the memory card can be directly accessed. Therefore, high-speed data transfer to the memory of the memory card can be achieved. 2) Since data input/output to/from the memory of the memory card can be encrypted, a security function of the data can be implemented. Therefore, data can be securely protected on a wireless communication between digital devices. Also, since a security function can be implemented, a hybrid memory card having a copy protection function for copyright protection can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A card, comprising:
a memory configured to rewritably store data;
a communication unit configured to transmit/receive data via a wireless communication;
an interface connectable to an external device; and
a controller configured to execute direct access control to said memory via said communication unit, said controller being set in a direct access mode by a command supplied via said interface.

2. The card according to claim 1, wherein said controller receives data which is sent from said communication unit and writes the received data in said memory, without transferring the data via said interface in execution of the direct access control.

3. The card according to claim 1, wherein said controller reads data from said memory and sends the read data to said communication unit, without transferring the data via said interface in execution of the direct access control.

4. A card, comprising:
a memory configured to rewritably store data;
an encryption processor configured to execute an encryption/decryption process of data to be written in said memory or data read out from said memory;
a communication unit configured to transmit/receive data via a wireless communication;
an interface connectable to an external device; and
a controller configured to execute direct access control to said memory via said communication unit and ON/OFF control of said encryption processor, said controller being set in a direct access mode and a security mode by a command supplied via said interface.

5. The card according to claim 4, wherein said controller receives data which is sent from said communication unit, causing said encryption processor to decrypt the received data, and writes the decrypted data in said memory, without transferring the data via said interface in execution of the direct access control.

6. The card according to claim 4, wherein said controller reads data from said memory, causing said encryption processor to encrypt the read data, and sends the encrypted data to said communication unit, without transferring the data via said interface in execution of the direct access control.

7. A card, comprising:
a memory configured to rewritably store data;
a communication unit configured to transmit/receive data via a wireless communication;
an interface connectable to an external device;
a switch configured to set a direct access function; and
a controller configured to execute direct access control to said memory via said communication unit, said controller being set in a direct access mode by an operation of a switch.

8. The card according to claim 7, wherein:
said switch is configured to set a security function, and
said controller is configured to execute ON/OFF control of said encryption processor in accordance with an operation of said switch.

9. A wireless communication method applied to a system having a first electronic device using a first card and a second electronic device using a second card, said method comprising:
accessing from said first electronic device via said first card to said second card by wireless communication; and
executing direct access control to a memory in said second card by said second card in response to the accessing from said first electronic device, said second card being set in a direct access mode by a command supplied from said second electronic device.

10. The method according to claim 9, wherein said second card receives data which is sent from said first card and writes the received data in said memory, without transferring the data to said second electronic device in execution of the direct access control.

11. The method according to claim 9, wherein said second card reads data from said memory and sends the read data to said first card, without transferring the data to said second electronic device in execution of the direct access control.

12. The method according to claim 9, further comprising executing an encryption/decryption process of data to be written in said memory or data read out from said memory.

13. A wireless communication method applied to a system having a first electronic device using a first card and a second electronic device using a second card, said method comprising:
accessing from said first electronic device via said first card to said second card by wireless communication; and
executing direct access control to a memory in said second card by said second card in response to the accessing from said first electronic device, said second card being set in a direct access mode by an operation of a switch.

14. The card according to claim 13, further comprising executing an encryption/decryption process of data to be written in said memory or data read out from said memory by an operation of said switch.
